(19) United States
(12) Patent Application Publication
(10) Pub. No.: US 2025/0272086 A1
(43) Pub. Date: Aug. 28, 2025

(54) METHOD AND SYSTEM FOR GENERATING RECIPES FOR CODE MAINTENANCE

(71) Applicant: JPMorgan Chase Bank, N.A., New York, NY (US)

(72) Inventors: Ran ZMIGROD, Cambridge (GB); Farima FARMAHINIFARAHANI, Santa Ciara, CA (US); Eric J CONNELLY, East Meadow, NY (US); Petr BABKIN, San Francisco, CA (US); Salwa Husam ALAMIR, Bournemouth (GB); Daniel CHEN, Woodcliff Lake, NJ (US); Xiaomo LIU, Manhasset, NY (US)

(73) Assignee: JPMorgan Chase Bank, N.A., New York, NY (US)

(21) Appl. No.: 18/590,411

(22) Filed: Feb. 28, 2024

(51) Int. Cl. G06F 8/70; G06F 40/186; G06F 40/205

(52) U.S. Cl. CPC G06F 8/70; G06F 40/186; G06F 40/205

(57) ABSTRACT

A method and a system for automating a process of generating a recipe for software code maintenance by recommending sub-recipes that are needed to write a new recipe are provided. The method includes: receiving a first user input that includes information that relates to the new recipe, such as a recipe name and a recipe description; analyzing the information that relates to the new recipe in order to automatically determine a list of sub-recipes for possible inclusion in the new recipe and a corresponding set of scores that indicate a probability that each sub-recipe is suitable for inclusion in the new recipe; transmitting, to the user, the list and a request for user feedback; and receiving a second user input that includes a set of selected sub-recipes to be included in the new recipe.

### BACKGROUND

### 1. Field of the Disclosure

This technology generally relates to methods and systems for maintaining software code, and more particularly to methods and systems for automating a process of generating a recipe for software code maintenance by recommending sub-recipes that are needed to write a new recipe.

### 2. Background Information

Software engineering teams must maintain their code to be up to date with the latest packages. This is a continuous process, and so teams must find methods to automate this process. One such way is through recipes, or scripts that call user functions, that automatically apply changes to code-bases. These recipes shift the burden of work of code maintenance towards the creation of these recipes.

Typically, the process of generating such recipes is a manual creation process that may be time consuming and repetitive. Accordingly, there is a need for a method for automating a process of generating a recipe for software code maintenance by recommending sub-recipes that are needed to write a new recipe.

### SUMMARY

The present disclosure, through one or more of its various aspects, embodiments, and/or specific features or sub-components, provides, inter alia, various systems, servers, devices, methods, media, programs, and platforms for automating a process of generating a recipe for software code maintenance by recommending sub-recipes that are needed to write a new recipe.

According to an aspect of the present disclosure, a method for generating a recipe for software code maintenance is provided. The method is implemented by at least one processor. The method includes: receiving, by the at least one processor from a user, a first user input that includes information that relates to a first recipe; analyzing, by the at least one processor, the information that relates to the first recipe in order to automatically determine a list of sub-recipes for possible inclusion in the first recipe; transmitting, by the at least one processor to the user, the list and a request for user feedback; and receiving, by the at least one processor from the user in response to the transmission of the list and the request for user feedback, a second user input that includes a set of selected sub-recipes to be included in the first recipe.

When the information that relates to the first recipe includes a recipe name, the analyzing may include: parsing the recipe name to determine a library, a package, a tool, and an action name; using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; and generating the list such that each of the at least one first sub-recipe and each respective probability score is included in the list.

The first forecast may include, for each first sub-recipe, a corresponding first list of arguments. The second user input may further include at least one from among information that relates to at least one argument included in the first list of arguments and information that relates to a respective user edit of a name of at least one first sub-recipe.

When the information that relates to the first recipe includes a recipe description, the analyzing may include: parsing the recipe description to determine a set of word embeddings and a set of sentence embeddings; comparing the set of word embeddings and the set of sentence embeddings to identify at least one related recipe; using each of the at least one related recipe to generate a second forecast that relates to at least one second sub-recipe for possible inclusion in the first recipe, together with a respective similarity score for each of the at least one second sub-recipe; and generating the list such that each of the at least one second sub-recipe and each respective similarity score is included in the list.

The second forecast may include, for each second sub-recipe, a corresponding second list of arguments. The second user input may further include at least one from among information that relates to at least one argument included in the second list of arguments and information that relates to a respective user edit of a name of at least one second sub-recipe.

The analyzing may be performed by applying an artificial intelligence (AI) algorithm that is trained by using a data set that contains historical information that relates to previously-used recipes.

The method may further include: augmenting the data set by adding the set of selected sub-recipes to the historical information that relates to the previously-used recipes; and updating a training of the AI algorithm by using the augmented data set.

The information that relates to the first recipe may include both a recipe name and a recipe description. The analyzing may include: parsing the recipe name to determine a library, a package, a tool, and an action name; using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; parsing the recipe description to determine a set of word embeddings and a set of sentence embeddings; comparing the set of word embeddings and the set of sentence embeddings to identify at least one related recipe; using each of the at least one related recipe to generate a second forecast that relates to at least one second sub-recipe for possible inclusion in the first recipe, together with a respective similarity score for each of the at least one second sub-recipe; and generating the list such that each of the at least one first sub-recipe, each respective probability score, each of the at least one second sub-recipe, and each respective similarity score is included in the list.

The method may further include displaying, on a display, a user interface that includes a first field that prompts the user to provide the recipe name, a second field that prompts the user to provide the recipe description, a first clickable button that facilitates a user submission of the first user input, a third field that shows the list of sub-recipes for possible inclusion in the first recipe, a fourth field that shows a recipe template that is editable by the user, and a second clickable button that facilitates a user submission of the second user input.

According to another exemplary embodiment, a computing apparatus for generating a recipe for software code maintenance is provided. The computing apparatus includes a processor; a memory; a display; and a communication interface coupled to each of the processor, the memory, and the display. The processor is configured to: receive, from a user via the communication interface, a first user input that includes information that relates to the first recipe; analyze the information that relates to first recipe in order to automatically determine a list of sub-recipes for possible inclusion in the first recipe; transmit, to the user via the communication interface, the list and a request for user feedback; and receive, from the user via the communication interface in response to the transmission of the list and the request for user feedback, a second user input that includes a set of selected sub-recipes to be included in the first recipe.

When the information that relates to the first recipe includes a recipe name, the processor may be further configured to perform the analysis by: parsing the recipe name to determine a library, a package, a tool, and an action name; using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; and generating the list such that each of the at least one first sub-recipe and each respective probability score is included in the list.

The first forecast may include, for each first sub-recipe, a corresponding first list of arguments. The second user input may further include at least one from among information that relates to at least one argument included in the first list of arguments and information that relates to a respective user edit of a name of at least one first sub-recipe.

When the information that relates to the first recipe includes a recipe description, the processor may be further configured to perform the analysis by: parsing the recipe description to determine a set of word embeddings and a set of sentence embeddings; comparing the set of word embeddings and the set of sentence embeddings to identify at least one related recipe; using each of the at least one related recipe to generate a second forecast that relates to at least one second sub-recipe for possible inclusion in the first recipe, together with a respective similarity score for each of the at least one second sub-recipe; and generating the list such that each of the at least one second sub-recipe and each respective similarity score is included in the list.

The second forecast may include, for each second sub-recipe, a corresponding second list of arguments. The second user input may further include at least one from among information that relates to at least one argument included in the second list of arguments and information that relates to a respective user edit of a name of at least one second sub-recipe.

The processor may be further configured to perform the analysis by applying an artificial intelligence (AI) algorithm that is trained by using a data set that contains historical information that relates to previously-used recipes.

The processor may be further configured to: augment the data set by adding the set of selected sub-recipes to the historical information that relates to the previously-used recipes; and update a training of the AI algorithm by using the augmented data set.

The information that relates to the first recipe may include both a recipe name and a recipe description. The processor may be further configured to perform the analysis by: parsing the recipe name to determine a library, a package, a tool, and an action name; using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; parsing the recipe description to determine a set of word embeddings and a set of sentence embeddings; comparing the set of word embeddings and the set of sentence embeddings to identify at least one related recipe; using each of the at least one related recipe to generate a second forecast that relates to at least one second sub-recipe for possible inclusion in the first recipe, together with a respective similarity score for each of the at least one second sub-recipe; and generating the list such that each of the at least one first sub-recipe, each respective probability score, each of the at least one second sub-recipe, and each respective similarity score is included in the list.

The processor may be further configured to cause the display to display a user interface that includes a first field that prompts the user to provide the recipe name, a second field that prompts the user to provide the recipe description, a first clickable button that facilitates a user submission of the first user input, a third field that shows the list of sub-recipes for possible inclusion in the first recipe, a fourth field that shows a recipe template that is editable by the user, and a second clickable button that facilitates a user submission of the second user input.

According to yet another exemplary embodiment, a non-transitory computer readable storage medium storing instructions for generating a recipe for software code maintenance is provided. The storage medium includes executable code which, when executed by a processor, causes the processor to: receive, from a user, a first user input that includes information that relates to the first recipe; analyze the information that relates to first recipe in order to automatically determine a list of sub-recipes for possible inclusion in the first recipe; transmit, to the user, the list and a request for user feedback; and receive, from the user in response to the transmission of the list and the request for user feedback, a second user input that includes a set of selected sub-recipes to be included in the first recipe.

The information that relates to the first recipe may include both a recipe name and a recipe description. When executed by the processor, the executable code may further cause the processor to perform the analysis by: parsing the recipe name to determine a library, a package, a tool, and an action name; using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; parsing the recipe description to determine a set of word embeddings and a set of sentence embeddings; comparing the set of word embeddings and the set of sentence embeddings to identify at least one related recipe; using each of the at least one related recipe to generate a second forecast that relates to at least one second sub-recipe for possible inclusion in the first recipe, together with a respective similarity score for each of the at least one second sub-recipe; and generating the list such that each of the at least one first sub-recipe, each respective probability score, each of the at least one second sub-recipe, and each respective similarity score is included in the list.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating a process of generating a recipe for software code maintenance by recommending sub-recipes that are needed to write a new recipe.

FIG. 4 is a flowchart of an exemplary process for implementing a method for automating a process of generating a recipe for software code maintenance by recommending sub-recipes that are needed to write a new recipe.

FIG. 5 is an illustration of an example of a recipe and its components.

FIG. 6 is a flow diagram of an automated process of generating a recipe for software code maintenance by recommending sub-recipes that are needed to write a new recipe, according to an exemplary embodiment.

FIG. 7 is a screenshot of a user interface for a system that implements a method for automating a process of generating a recipe for software code maintenance by recommending sub-recipes that are needed to write a new recipe, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

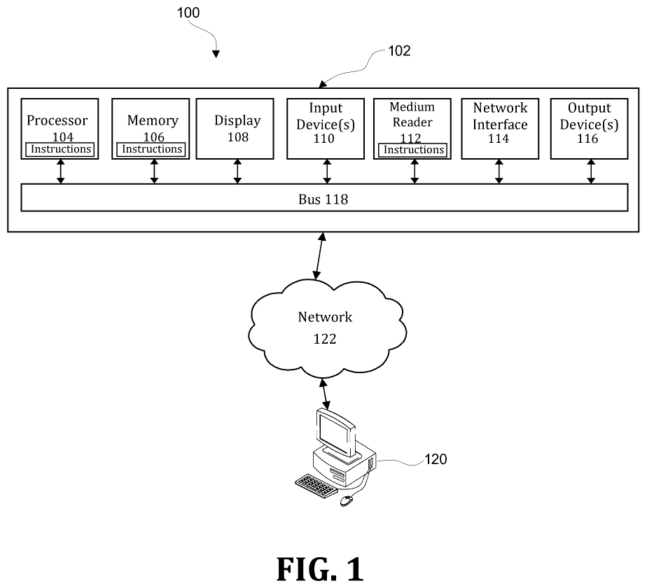

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automating a process of generating a recipe for software code maintenance by recommending sub-recipes that are needed to write a new recipe.

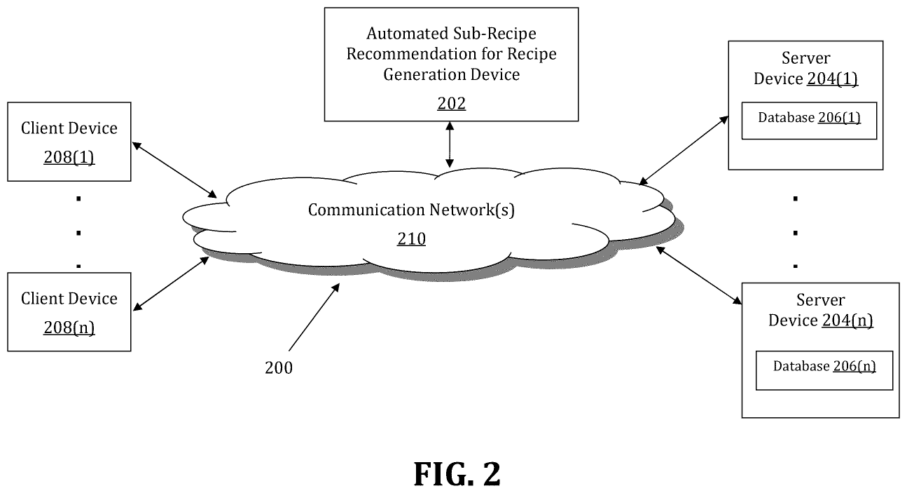

Referring to FIG. 2, a schematic of an exemplary network environment 200 for implementing a method for automating a process of generating a recipe for software code maintenance by recommending sub-recipes that are needed to write a new recipe is illustrated. In an exemplary embodiment, the method is executable on any networked computer platform, such as, for example, a personal computer (PC).

The method for automating a process of generating a recipe for software code maintenance by recommending sub-recipes that are needed to write a new recipe may be implemented by an Automated Sub-Recipe Recommendation for Recipe Generation (ASRRRG) device 202. The ASRRRG device 202 may be the same or similar to the computer system 102 as described with respect to FIG. 1. The ASRRRG device 202 may store one or more applications that can include executable instructions that, when executed by the ASRRRG device 202, cause the ASRRRG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ASRRRG device 202 itself, may be located in virtual server(s) running in a cloud-based computing environment rather than being tied to one or more specific physical network computing devices. Also, the application(s) may be running in one or more virtual machines (VMs) executing on the ASRRRG device 202. Additionally, in one or more embodiments of this technology, virtual machine(s) running on the ASRRRG device 202 may be managed or supervised by a hypervisor.

In the network environment 200 of FIG. 2, the ASRRRG device 202 is coupled to a plurality of server devices 204(1)-204(n) that hosts a plurality of databases 206(1)-206(n), and also to a plurality of client devices 208(1)-208(n) via communication network(s) 210. A communication interface of the ASRRRG device 202, such as the network interface 114 of the computer system 102 of FIG. 1, operatively couples and communicates between the ASRRRG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ASRRRG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ASRRRG devices that efficiently implement a method for automating a process of generating a recipe for software code maintenance by recommending sub-recipes that are needed to write a new recipe.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ASRRRG device 202 may be a standalone device or integrated with one or more other devices or apparatuses, such as one or more of the server devices 204(1)-204(n), for example. In one particular example, the ASRRRG device 202 may include or be hosted by one of the server devices 204(1)-204(n), and other arrangements are also possible. Moreover, one or more of the devices of the ASRRRG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ASRRRG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical recipes and information that relates to software code-base configurations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204 (n) are not limited to a particular configuration. Thus, the server devices 204(1)-204 (n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ASRRRG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ASRRRG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ASRRRG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ASRRRG device 202, the server devices 204(1)-204(n), or the client devices 208(1)-208(n), for example, may be configured to operate as virtual instances on the same physical machine. In other words, one or more of the ASRRRG device 202, the server devices 204(1)-204(n), or the client devices 208(1)-208(n) may operate on the same physical device rather than as separate devices communicating through communication network(s) 210. Additionally, there may be more or fewer ASRRRG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

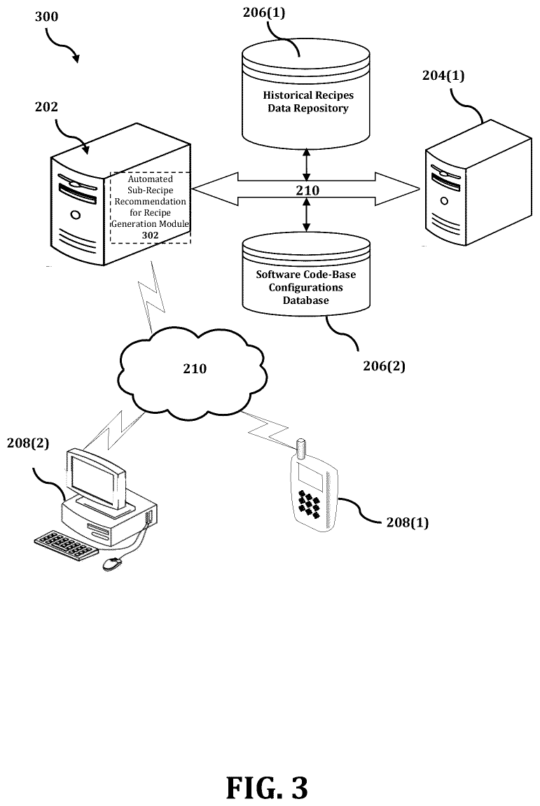

The ASRRRG device 202 is described and illustrated in FIG. 3 as including an automated sub-recipe recommendation for recipe generation module 302, although it may include other rules, policies, modules, databases, or applications, for example. As will be described below, the automated sub-recipe recommendation for recipe generation module 302 is configured to implement a method for automating a process of generating a recipe for software code maintenance by recommending sub-recipes that are needed to write a new recipe.

An exemplary process 300 for implementing a mechanism for automating a process of generating a recipe for software code maintenance by recommending sub-recipes that are needed to write a new recipe by utilizing the network environment of FIG. 2 is illustrated as being executed in FIG. 3. Specifically, a first client device 208(1) and a second client device 208(2) are illustrated as being in communication with ASRRRG device 202. In this regard, the first client device 208(1) and the second client device 208(2) may be “clients” of the ASRRRG device 202 and are described herein as such. Nevertheless, it is to be known and understood that the first client device 208(1) and/or the second client device 208(2) need not necessarily be “clients” of the ASRRRG device 202, or any entity described in association therewith herein. Any additional or alternative relationship may exist between either or both of the first client device 208(1) and the second client device 208(2) and the ASRRRG device 202, or no relationship may exist.

Further, ASRRRG device 202 is illustrated as being able to access a historical recipes data repository 206(1) and a software code-base configurations database 206(2). The automated sub-recipe recommendation for recipe generation module 302 may be configured to access these databases for implementing a method for automating a process of generating a recipe for software code maintenance by recommending sub-recipes that are needed to write a new recipe.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ASRRRG device 202 via broadband or cellular communication. Of course, these embodiments are merely exemplary and are not limiting or exhaustive.

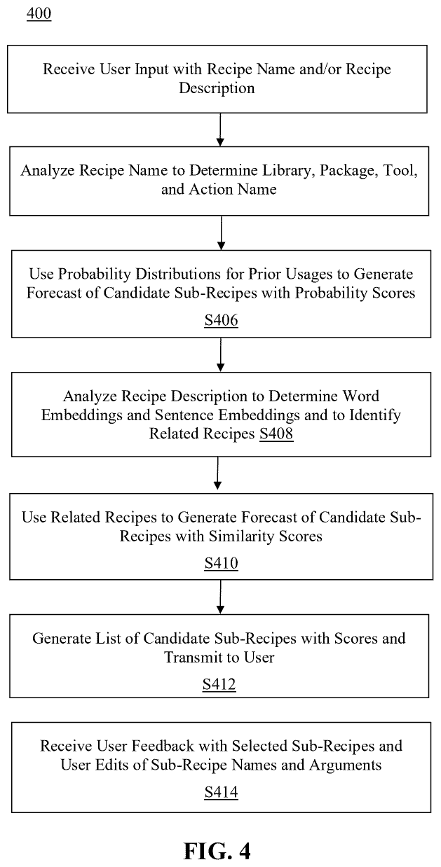

Upon being started, the automated sub-recipe recommendation for recipe generation module 302 executes a process for automating a process of generating a recipe for software code maintenance by recommending sub-recipes that are needed to write a new recipe. An exemplary process for automating a process of generating a recipe for software code maintenance by recommending sub-recipes that are needed to write a new recipe is generally indicated at flowchart 400 in FIG. 4.

In process 400 of FIG. 4, at step S402, the automated sub-recipe recommendation for recipe generation module 302 receives a first user input that includes information that relates to a new recipe to be generated for a purpose of maintaining software. In an exemplary embodiment, the information includes either or both of a recipe name and a recipe description. In an exemplary embodiment, the automated sub-recipe recommendation for generation module 302 causes a user interface (UI) to be displayed upon a display that is accessible to the user, and the UI includes fields for prompting the user to provide the first input.

At step S404, when the information received in the first user input includes the recipe name, the automated sub-recipe recommendation for recipe generation module 302 analyzes the recipe name to determine a library, a package, a tool, and an action name that are associated with the recipe name. Then, at step S406, the automated sub-recipe recommendation for recipe generation module 302 uses a probability distribution that is associated with a prior usage of the library, the package, the tool, and the action name determined in step S404 in order to generate a first forecast that includes at least one candidate sub-recipe that may possibly be suitable for inclusion in the new recipe, together with a respective probability score for each candidate sub-recipe. In an exemplary embodiment, the first forecast may also include a respective set of arguments for each candidate sub-recipe.

At step S408, when the information received in the first user input includes the recipe description, the automated sub-recipe recommendation for recipe generation module 302 analyzes the recipe description to determine word embeddings and sentence embeddings contained therein, and then compares the word embeddings and the sentence embeddings with descriptions of various existing sub-recipes to identify at least one related sub-recipe, together with a respective similarity score for each such related sub-recipe. Then, at step S410, the automated sub-recipe recommendation for recipe generation module 302 uses each related sub-recipe identified in step S408 to generate a second forecast that includes at least one candidate sub-recipe that may possibly be suitable for inclusion in the new recipe, together with the corresponding similarity score.

At step S412, the automated sub-recipe recommendation for recipe generation module 302 uses the first forecast and the second forecast to assemble a list of candidate sub-recipes, and then, upon generation thereof, transmits the assembled list of candidate sub-recipes with their corresponding probability scores and/or similarity scores to the user. In an exemplary embodiment, the list of candidate sub-recipes with corresponding scores may be displayed in a different field via the UI so that the user can easily see the list.

At step S414, the automated sub-recipe recommendation for recipe generation module 302 prompts the user to submit a second user input by which the user provides feedback regarding the list of candidate sub-recipes. In an exemplary embodiment, the user is invited to indicate which candidate sub-recipes are to be included in the new recipe, and also to provide edits of the names and/or descriptions of the sub-recipes to be included. In an exemplary embodiment, the UI includes another field that is configured to receive the second user input, together with a clickable button that is configured to facilitate a submission of the user feedback and/or an acceptance of the proposed new recipe. When the second user input is received by the automated sub-recipe recommendation for recipe generation module 302, then the recipe generation process 400 is complete.

Software engineering teams must maintain their code to be up to date with the latest packages. This is a continuous process and so teams must find methods to automate this process. One such way is through recipe, i.e., scripts that call user functions, that automatically apply changes to code-bases. These recipes shift the burden of work of code maintenance towards the creation of these recipes.

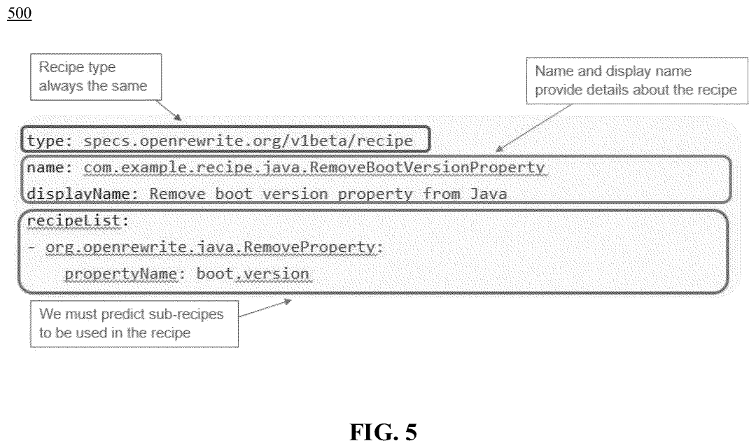

FIG. 5 is an illustration 500 of an example of a recipe and its components. The type of the recipe is deterministic and is always predictable. The name and display name describe the recipe. Additionally, a description may also be provided in a textual format in order to allow for a more detailed way to describe the recipe. In an exemplary embodiment, the most difficult component of the recipes to generate is the recipe list, which includes a list of previously existing recipes, also referred to herein as sub-recipes. Each sub-recipe may correspond to a respective list of arguments that may require user input. In an exemplary embodiment, the proposed inventive system aims to predict the sub-recipes in the recipe list based on its name and/or a user description of the target recipe.

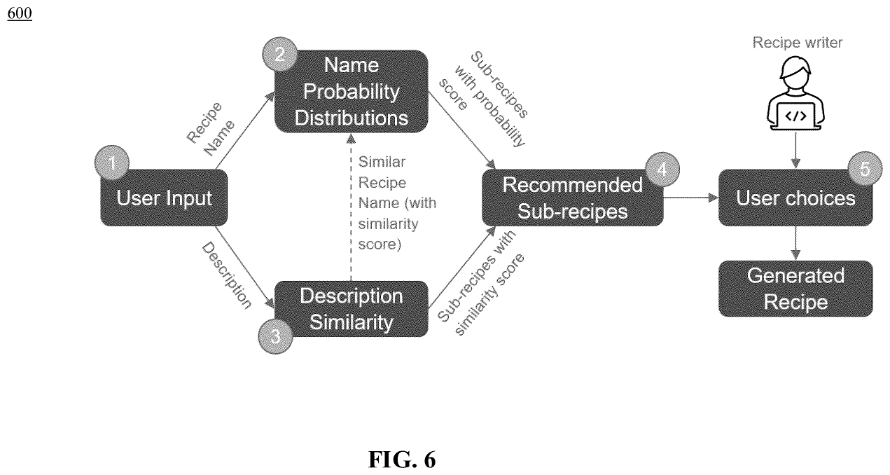

FIG. 6 is a flow diagram 600 of an automated process of generating a recipe for software code maintenance by recommending sub-recipes that are needed to write a new recipe, according to an exemplary embodiment.

Item 1 in flow diagram 600 refers to user input. In an exemplary embodiment, the proposed system considers multiple different user inputs, such as, for example, the target name of the new recipe and/or a description of the new recipe. This description can be in the form of an official recipe description or in the form of a user query.

Item 2 in flow diagram 600 refers to prediction via recipe name. When a name is provided as a user input, various components of the recipe name are considered. In an exemplary embodiment, a recipe name can be broken down into a library, a package, a tool, and an action name. Probability distributions of how these combinations have been used in previous recipes may be advantageously used for predicting which sub-recipes will likely be needed. In an exemplary embodiment, a machine learning model that is trained by using the previous recipes may apply an artificial intelligence (AI) algorithm in order to make advantageous use of such probability distributions.

Item 3 in flow diagram 600 refers to prediction via description. When a description is provided as a user input, word embeddings and sentence embeddings may be used to find similar existing recipes, based on existing descriptions. Word and sentence embeddings convert a piece of text to a list of numbers, which can then be compared with other embeddings (i.e., other lists of numbers) to find related recipes and associated similarity scores. In an exemplary embodiment, a prediction of suitable sub-recipes may be made by considering the sub-recipes used in the similar existing recipes.

Item 4 in flow diagram 600 refers to sub-recipe predictions. In an exemplary embodiment, the processes described above for items 2 and 3 are used to predict a list of potential sub-recipes to aid in recipe generation. When both a name and description are provided, both processes are used. If only a name is provided, only the process re item 2 is used. If only a description is provided, the process re item 3 is first applied, and then the names of the similar sub-recipes may be employed in order to also to use the process re item 2. In an exemplary embodiment, each sub-recipe is also assigned a score based on the probability or similarity scores determined as described above with respect to items 2 and 3 respectively.

Item 5 in flow diagram 600 refers to enabling a user to select recommendations. In an exemplary embodiment, the user can select which of the recommended sub-recipes to include in the new recipe, and the user is also able to edit their names as well as their arguments. Once selections and edits have been made, the accepted recipe may be used to better train the probability distributions used for recommending sub-recipes.

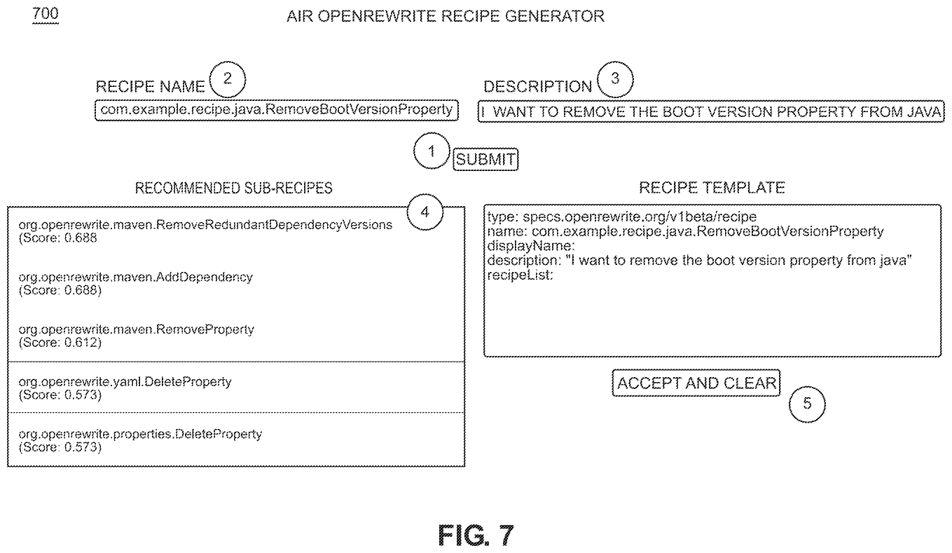

FIG. 7 is a screenshot 700 of a user interface (UI) for a system that implements a method for automating a process of generating a recipe for software code maintenance by recommending sub-recipes that are needed to write a new recipe, according to an exemplary embodiment. In the UI shown in screenshot 700, a selection may be made using a live editor with an “Accept” button. The numbered features of the UI shown in screenshot 700 correspond to the numbered items shown in flow diagram 600.

Accordingly, with this technology, an optimized process for automating a process of generating a recipe for software code maintenance by recommending sub-recipes that are needed to write a new recipe is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a recipe for software code maintenance, the method being implemented by at least one processor, the method comprising:
receiving, by the at least one processor from a user, a first user input that includes information that relates to a first recipe;
analyzing, by the at least one processor, the information that relates to the first recipe in order to automatically determine a list of sub-recipes for possible inclusion in the first recipe;
transmitting, by the at least one processor to the user, the list and a request for user feedback; and
receiving, by the at least one processor from the user in response to the transmission of the list and the request for user feedback, a second user input that includes a set of selected sub-recipes to be included in the first recipe.

2. The method of claim 1, wherein when the information that relates to the first recipe includes a recipe name, the analyzing comprises:
parsing the recipe name to determine a library, a package, a tool, and an action name;
using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; and
generating the list such that each of the at least one first sub-recipe and each respective probability score is included in the list.

3. The method of claim 2, wherein the first forecast includes, for each first sub-recipe, a corresponding first list of arguments, and
wherein the second user input further includes at least one from among information that relates to at least one argument included in the first list of arguments and information that relates to a respective user edit of a name of at least one first sub-recipe.

4. The method of claim 1, wherein when the information that relates to the first recipe includes a recipe description, the analyzing comprises:
parsing the recipe description to determine a set of word embeddings and a set of sentence embeddings;
comparing the set of word embeddings and the set of sentence embeddings to identify at least one related recipe;
using each of the at least one related recipe to generate a second forecast that relates to at least one second sub-recipe for possible inclusion in the first recipe, together with a respective similarity score for each of the at least one second sub-recipe; and
generating the list such that each of the at least one second sub-recipe and each respective similarity score is included in the list.

5. The method of claim 4, wherein the second forecast includes, for each second sub-recipe, a corresponding second list of arguments, and
wherein the second user input further includes at least one from among information that relates to at least one argument included in the second list of arguments and information that relates to a respective user edit of a name of at least one second sub-recipe.

6. The method of claim 1, wherein the analyzing is performed by applying an artificial intelligence (AI) algorithm that is trained by using a data set that contains historical information that relates to previously-used recipes.

7. The method of claim 6, further comprising:
augmenting the data set by adding the set of selected sub-recipes to the historical information that relates to the previously-used recipes; and
updating a training of the AI algorithm by using the augmented data set.

8. The method of claim 1, wherein the information that relates to the first recipe includes both a recipe name and a recipe description, and
wherein the analyzing comprises:
parsing the recipe name to determine a library, a package, a tool, and an action name;
using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe;
parsing the recipe description to determine a set of word embeddings and a set of sentence embeddings;
comparing the set of word embeddings and the set of sentence embeddings to identify at least one related recipe;
using each of the at least one related recipe to generate a second forecast that relates to at least one second sub-recipe for possible inclusion in the first recipe, together with a respective similarity score for each of the at least one second sub-recipe; and
generating the list such that each of the at least one first sub-recipe, each respective probability score, each of the at least one second sub-recipe, and each respective similarity score is included in the list.

9. The method of claim 8, further comprising displaying, on a display, a user interface that includes a first field that prompts the user to provide the recipe name, a second field that prompts the user to provide the recipe description, a first clickable button that facilitates a user submission of the first user input, a third field that shows the list of sub-recipes for possible inclusion in the first recipe, a fourth field that shows a recipe template that is editable by the user, and a second clickable button that facilitates a user submission of the second user input.

10. A computing apparatus for generating a recipe for software code maintenance, the computing apparatus comprising:
a processor;
a memory;
a display; and
a communication interface coupled to each of the processor, the memory, and the display,
wherein the processor is configured to:
receive, from a user via the communication interface, a first user input that includes information that relates to a first recipe;
analyze the information that relates to the first recipe in order to automatically determine a list of sub-recipes for possible inclusion in the first recipe;
transmit, to the user via the communication interface, the list and a request for user feedback; and
receive, from the user via the communication interface in response to the transmission of the list and the request for user feedback, a second user input that includes a set of selected sub-recipes to be included in the first recipe.

11. The computing apparatus of claim 10, wherein when the information that relates to the first recipe includes a recipe name, the processor is further configured to perform the analysis by:
parsing the recipe name to determine a library, a package, a tool, and an action name;
using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe; and
generating the list such that each of the at least one first sub-recipe and each respective probability score is included in the list.

12. The computing apparatus of claim 11, wherein the first forecast includes, for each first sub-recipe, a corresponding first list of arguments, and
wherein the second user input further includes at least one from among information that relates to at least one argument included in the first list of arguments and information that relates to a respective user edit of a name of at least one first sub-recipe.

13. The computing apparatus of claim 10, wherein when the information that relates to the first recipe includes a recipe description, the processor is further configured to perform the analysis by:
parsing the recipe description to determine a set of word embeddings and a set of sentence embeddings;
comparing the set of word embeddings and the set of sentence embeddings to identify at least one related recipe;
using each of the at least one related recipe to generate a second forecast that relates to at least one second sub-recipe for possible inclusion in the first recipe, together with a respective similarity score for each of the at least one second sub-recipe; and
generating the list such that each of the at least one second sub-recipe and each respective similarity score is included in the list.

14. The computing apparatus of claim 13, wherein the second forecast includes, for each second sub-recipe, a corresponding second list of arguments, and
wherein the second user input further includes at least one from among information that relates to at least one argument included in the second list of arguments and information that relates to a respective user edit of a name of at least one second sub-recipe.

15. The computing apparatus of claim 10, wherein the processor is further configured to perform the analysis by applying an artificial intelligence (AI) algorithm that is trained by using a data set that contains historical information that relates to previously-used recipes.

16. The computing apparatus of claim 15, wherein the processor is further configured to:
augment the data set by adding the set of selected sub-recipes to the historical information that relates to the previously-used recipes; and
update a training of the AI algorithm by using the augmented data set.

17. The computing apparatus of claim 10, wherein the information that relates to the first recipe includes both a recipe name and a recipe description, and
wherein the processor is further configured to perform the analysis by:
parsing the recipe name to determine a library, a package, a tool, and an action name;
using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe;
parsing the recipe description to determine a set of word embeddings and a set of sentence embeddings;
comparing the set of word embeddings and the set of sentence embeddings to identify at least one related recipe;
using each of the at least one related recipe to generate a second forecast that relates to at least one second sub-recipe for possible inclusion in the first recipe, together with a respective similarity score for each of the at least one second sub-recipe; and
generating the list such that each of the at least one first sub-recipe, each respective probability score, each of the at least one second sub-recipe, and each respective similarity score is included in the list.

18. The computing apparatus of claim 17, wherein the processor is further configured to cause the display to display a user interface that includes a first field that prompts the user to provide the recipe name, a second field that prompts the user to provide the recipe description, a first clickable button that facilitates a user submission of the first user input, a third field that shows the list of sub-recipes for possible inclusion in the first recipe, a fourth field that shows a recipe template that is editable by the user, and a second clickable button that facilitates a user submission of the second user input.

19. A non-transitory computer readable storage medium storing instructions for generating a recipe for software code maintenance, the storage medium comprising executable code which, when executed by a processor, causes the processor to:
receive, from a user, a first user input that includes information that relates to a first recipe;
analyze the information that relates to the first recipe in order to automatically determine a list of sub-recipes for possible inclusion in the first recipe;
transmit, to the user, the list and a request for user feedback; and
receive, from the user in response to the transmission of the list and the request for user feedback, a second user input that includes a set of selected sub-recipes to be included in the first recipe.

20. The storage medium of claim 19, wherein the information that relates to the first recipe includes both a recipe name and a recipe description, and
wherein when executed by the processor, the executable code further causes the processor to perform the analysis by:
parsing the recipe name to determine a library, a package, a tool, and an action name;
using a probability distribution that relates to at least one prior usage of each of the library, the package, the tool, and the action name to generate a first forecast that relates to at least one first sub-recipe for possible inclusion in the first recipe, together with a respective probability score for each of the at least one first sub-recipe;
parsing the recipe description to determine a set of word embeddings and a set of sentence embeddings;
comparing the set of word embeddings and the set of sentence embeddings to identify at least one related recipe;
using each of the at least one related recipe to generate a second forecast that relates to at least one second sub-recipe for possible inclusion in the first recipe, together with a respective similarity score for each of the at least one second sub-recipe; and
generating the list such that each of the at least one first sub-recipe, each respective probability score, each of the at least one second sub-recipe, and each respective similarity score is included in the list.
